(19) United States
(12) Patent Application Publication
(10) Pub. No.: US 2021/0218320 A1
(43) Pub. Date: Jul. 15, 2021

(54) ROTOR AND MOTOR

(71) Applicant: MABUCHI MOTOR CO., LTD., Matsudo City (JP)

(72) Inventors: Yasuhiro HASHIMOTO, Matsudo City (JP); Hideyuki UZAWA, Matsudo City (JP); Keiji NAKAMURA, Matsudo City (JP)

(73) Assignee: MABUCHI MOTOR CO., LTD., Matsudo City (JP)

(21) Appl. No.: 16/743,438

(22) Filed: Jan. 15, 2020

(51) Int. Cl. H02K 13/10; H01R 39/46

(52) U.S. Cl. CPC H02K 13/105; H01R 39/04; H01R 39/46

(57) ABSTRACT

A rotor is provided with: a rotor core which rotates integrally with a shaft and has a plurality of radially extending teeth; windings including coil portions wound around the teeth; a commutator that is attached to the rotor core and integrally rotates with the shaft, the commutator including metal commutator segments having contact portions with which precious metal brushes make sliding contact, and a plurality of terminals to which the windings are bonded; elements which include capacitors and respectively electrically connecting terminals to which both ends of the coil portions of the same phase are connected; and a coating layer formed of an oil applied to the contact portions. A motor includes this rotor.

### FIELD

The present invention relates to a rotor with a commutator that contacts precious metal brushes, and to a motor equipped with the rotor.

### BACKGROUND

Typically, as a motor with brushes, a so-called inner-rotor type motor is generally known which is provided with a stator having permanent magnets fixed on an inner peripheral surface of a bottomed and tubular housing, and a rotor fixed to a shaft and having a core with windings wound thereon, where the rotor is rotatably accommodated on the inside of the stator. The rotor has a commutator fixed to the shaft. The commutator includes metal commutator segments attached to an insulating core. The metal commutator segments include contact portions with which brushes make sliding contact, and terminals to which windings are bonded.

The lifetime of the rotor can be extended by limiting or controlling the wear of the brushes, or by maintaining the contact portions of the commutator segments in good state. For example, JP-A-2001-119904 discloses a metal brush/commutator configuration in which the contact portions (electromechanical sliding surfaces) of the commutator segments are subjected to mechanical transfer using a super-mirror surface via lubricating oil. This configuration is said to make it possible to limit or control adhesive wear due to metal-to-metal welding of the brush and the commutator, and to thereby reduce brush wear or loss.

### SUMMARY

It is known that, at the electrical contact portion configured of the contact portions of the commutator segments and brushes, when the contact between the contact portions and the brush is broken, the energy stored in the windings is released, generating a spark. Typical rotors are often equipped with a ceramic disc varistor (hereafter simply referred to as a “varistor”) to prevent the spark.

However, when the power supply voltage inputted to the rotor is relatively high (in the case of high input), a varistor alone may not be sufficient to prevent the spark. In this case, if the motor is used in an atmosphere in which silicone gas (siloxane compound having a low molecular weight) exists, the silicone may be decomposed by the spark or sliding heat and an insulator (silicon dioxide) may be produced at the electrical contact portion, resulting in a so-called contact fault in which electrical conduction is blocked. Particularly, in the case of a motor in which precious metal brushes are adopted, because a precious metal is used at the part of the brush in contact with the commutator segments, the contact area between the brush and the commutator is small compared to a carbon brush. In addition, the pressure with which the brush is pressed against the commutator is relatively small, so that even a small amount of insulator produced leads to a contact fault. Accordingly, it is highly desirable to prevent sparking at the electrical contact portion of the rotor.

According to an aspect of embodiments, a rotor includes: a rotor core that rotates integrally with a shaft and includes a plurality of radially extending teeth; a winding including a coil portion wound around the teeth; a commutator that is attached to the rotor core and rotates integrally with the shaft, the commutator including a contact portion with which precious metal brushes make sliding contact, and a metal commutator segment having a plurality of terminals to which the winding is bonded; an element including a capacitor and respectively electrically connecting the terminals to which both ends of the coil portion of the same phase are connected; and a coating layer formed of an oil applied to the contact portion. The coil portion is wound around one or a plurality of the teeth. For example, when there is one coil portion, the element respectively electrically connects the terminals to which both ends of the one coil portion are connected.

### BRIEF DESCRIPTION OF DRAWINGS

FIG. 1 is an axial half cross-section view of a motor according to an embodiment;

FIG. 2 is an axial plan view of a rotor core of a rotor of the motor illustrated in FIG. 1;

FIG. 3 is a circuit diagram of the motor illustrated in FIG. 1;

FIG. 4 is a schematic perspective view of the rotor of the motor illustrated in FIG. 1 as viewed from the commutator side axially;

FIG. 5 illustrates test results, together with test conditions, obtained when the motor of FIG. 1 was tested in a silicone atmosphere;

FIG. 6 is a circuit diagram (modification) corresponding to the circuit diagram of FIG. 3 from which varistors have been removed;

FIG. 7 is a schematic perspective view (modification) of the rotor illustrated in FIG. 4 from which a varistor has been removed; and

FIG. 8 illustrates test results obtained when the motor of FIG. 6 was tested under the same test conditions as in FIG. 5.

### DESCRIPTION OF EMBODIMENTS

With reference to the drawings, a rotor and a motor according to an embodiment will be described. The following embodiment is merely exemplary and is not intended to exclude various modifications or application of technologies not explicitly mentioned in the following embodiment. Configurations of the present embodiment may be variously modified and implemented without departing from the spirit of the configurations. The configurations may be adopted or not adopted as needed, or combined, as appropriate.

[1. Configuration]

FIG. 1 is an axial half cross-section view of a motor 1 according to the present embodiment. The motor 1 of the present embodiment is a permanent magnetic field-type brushed DC motor, and is provided with a stator 2, a rotor 3, and an end bell 4. Herein, by way of example, the motor 1 is a 4 pole/6 slot motor in which the stator 2 has four magnetic poles of permanent magnets, and the rotor 3 has six winding slots. The stator 2 is provided with a housing 2A formed in the shape of a bottomed cylinder, and permanent magnets 2B fixed along the inner peripheral surface of the housing 2A. In a state in which the rotor 3 has been assembled, the permanent magnets 2B oppose a core 20 (hereafter referred to as a “rotor core 20”) of the rotor 3 radially, and extend axially so as to surround the rotor core 20.

The housing 2A has a circular hole 2h penetrating through the center of the bottom thereof. In the hole 2h, a bearing 2C rotatably supporting one end side of a shaft 5 (rotational shaft) of the rotor 3 is fitted. The end bell 4 is a lid member fixed to an opening portion of the housing 2A, and includes brushes 14 and terminals (not shown). In the motor 1 of the present embodiment, the brushes 14 have adopted precious metal fork-brushes in which a precious metal thin-film is formed at a portion that makes sliding contact with commutator segments. Exemplary types of the precious metal include silver alloys, copper alloys, gold alloys, and palladium alloys. A silver alloy layer may be laminated with another silver alloy layer, a gold alloy layer, or an alloy layer of other metals. The end bell 4 also includes a recess 4a in which a bearing 2D rotatably supporting the other end side of the shaft 5 is fitted, and a hole 4h through which the shaft 5 is passed.

The rotor 3 includes the rotor core 20 and a commutator 10, both of which rotate integrally with the shaft 5. The shaft 5 is a rotational shaft supporting the rotor 3, and also functions as an output shaft for extracting the output of the motor 1 externally. The rotor core 20 is a laminated core in which a plurality of steel sheets of identical shape is laminated. At the center of the rotor core 20, the shaft 5 is fixed with its axial direction aligned with the direction in which the steel sheets are laminated. The commutator 10 is fixed to the shaft 5 in a press-fitted manner, and has its circumferential position defined by being attached to the rotor core 20.

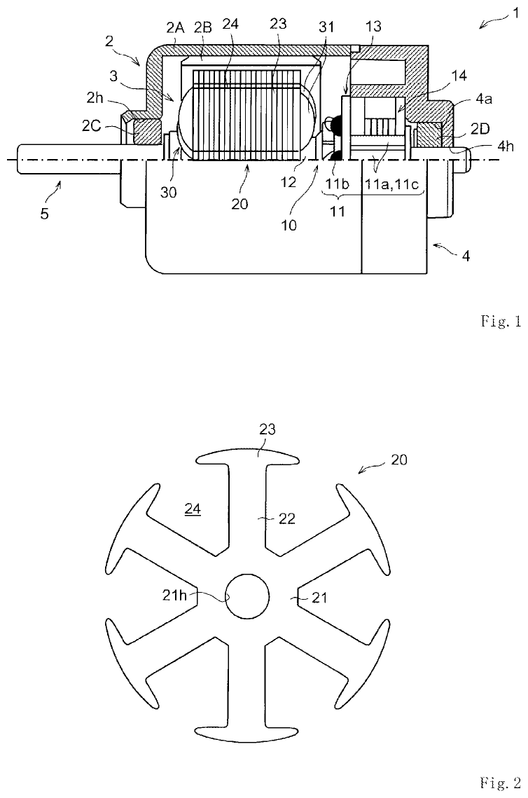

As illustrated in FIG. 2, the rotor core 20 of the present embodiment has an outer shape with a six-fold rotational symmetry in an axial view. Specifically, the rotor core 20 has a through-hole 21h at the center in which the shaft 5 is fixed. The rotor core 20 is configured of six teeth 22 extending radially outward from a central portion 21 in which the through-hole 21h is formed, and six arc portions 23 which are disposed at the outer end of each of the teeth 22 and are spaced apart from each other circumferentially. In the central portion 21, a projection (not shown) formed at the axial end of the commutator 10 is fitted, whereby the commutator 10 is positioned.

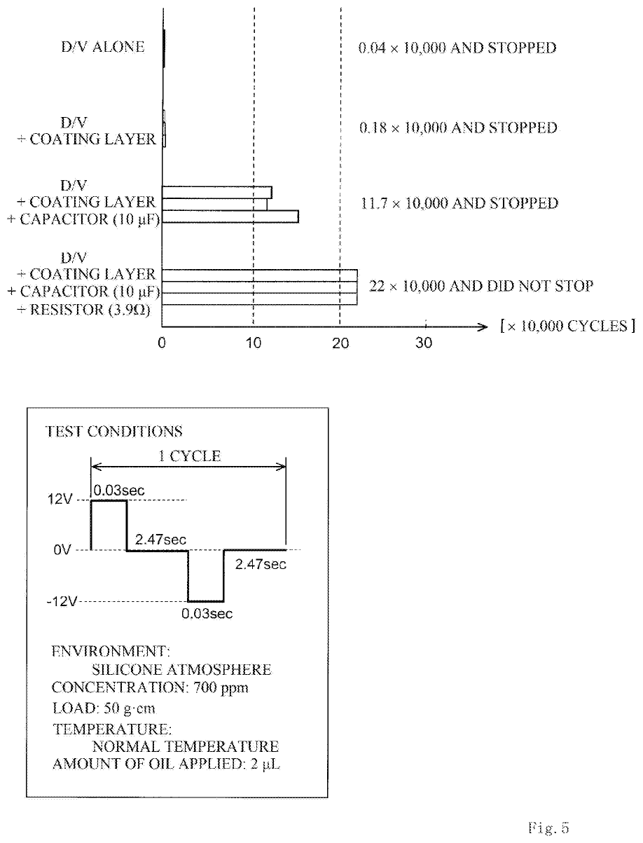

Windings 30 are arranged in slots 24 enclosed by circumferentially adjacent two teeth 22, the arc portions 23, and the central portion 21 of the rotor core 20. The slots 24, as illustrated in FIG. 1 and FIG. 4, are grooves (spaces) extending in the axial direction of the shaft 5, and there are six slots 24 formed at equal intervals in the circumferential direction of the rotor core 20. The windings 30 are wound a predetermined number of turns around the teeth 22 of the rotor core 20, through the slots 24 on both sides of the teeth 22.

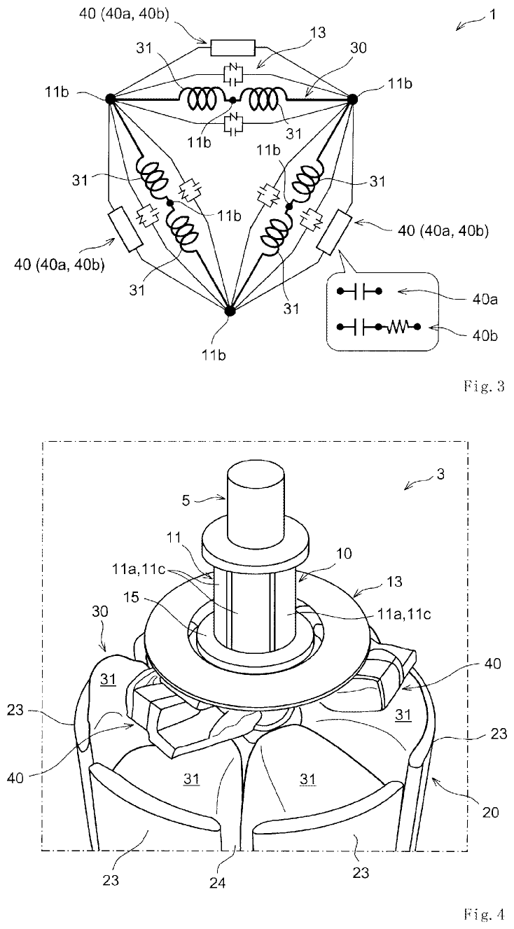

The windings 30 are insulated electric wires that are provided with an insulating film and that generate a magnetic force when an electric current flows therethrough. In the present embodiment, the windings 30 include coil portions 31 which are wound around the teeth 22 of the rotor core 20 with a predetermined tension in delta system of interconnection. In the present embodiment, the configuration illustrated in FIG. 3 is achieved by winding the windings 30 around the predetermined teeth 22, with the ends of the respective windings 30 connected to terminals 11b of the commutator 10 in predetermined relationships, where coil portions 31 of the same phase are formed by the windings 30 wound around two teeth 22 located at symmetric positions with respect to the shaft center. The teeth 22 of the rotor core 20 around which the windings 30 are wound are coated with an insulating layer (not shown) to maintain insulation.

As illustrated in FIG. 1 and FIG. 4, the commutator 10 includes a plurality of metal commutator segments 11 positioned with an axial gap from the rotor core 20, and a resin support 12 (see FIG. 1) to which the commutator segments 11 are mounted. In the present embodiment, the commutator 10 of the 6-slot rotor 3 has six commutator segments 11. The support 12 is a tubular insulating component having a shaft hole axially penetrating therethrough. The support 12 is fixed to the shaft 5 and attached to the rotor core 20, and rotates integrally with the shaft 5.

The commutator segments 11 include respective contact portions 11a with which the brushes 14 make sliding contact, and the terminals 11b to which the windings 30 are connected. The contact portions 11a each have a shape obtained by dividing a cylinder into six portions, and are fixed to the support 12 by an annular pressing member 15 (see FIG. 4) in a state in which the contact portions 11a are in surface contact with the outer peripheral surface of the cylinder portion of the support 12. The terminals 11b of the commutator segments 11 are portions extending from an arc-shaped end of the contact portions 11a radially outward and bent, and are shaped to be able to have the windings 30 locked thereon. The windings 30 locked on the terminal 11b are bonded by thermal bonding (a bonding process using heat), such as welding and soldering.

In the present embodiment, the contact portions 11a are provided with a coating layer 11c formed by applying an oil for protecting the motor 1 (rotor 3) from silicone contamination. The coating layer 11c functions as a protection film for protecting the contact portions 11a of the commutator segments 11 from silicone gas. In a state in which the function of the coating layer 11c can be performed, it is possible to prevent an electrical contact portion configured of the contact portions 11a of the commutator segments 11 and the brushes 14 from being contaminated by silicone gas, making it possible to extend the lifetime of the rotor 3 (motor 1). Exemplary types of the oil include poly-α-olefin oils, ester oils, and fluorine oils.

As illustrated in FIG. 1, FIG. 3, and FIG. 4, the rotor 3 of the present embodiment includes an annular disc varistor 13 (D/V, hereafter referred to as a “varistor 13”) disposed coaxially with the shaft 5. For example, the varistor 13 is disposed so as to surround the commutator 10, with a gap from one axial end (a so-called “wound mountain”) of the coil portions 31. The varistor 13, as illustrated in FIG. 3, has electrodes respectively electrically connected to the terminals 11b to which both ends of the same-phase coil portions 31 are connected, where the electrodes and the terminals 11b are thermally bonded by soldering or welding. In the rotor 3 of the present embodiment, of the six circumferentially arranged terminals 11b, the terminals 11b of the same potential located at the symmetric positions with respect to the shaft center are connected by short-circuit wires. Accordingly, two terminals 11b at circumferentially every other position are connected to the electrodes of the varistor 13.

The varistor 13 has the function of absorbing a surge voltage as a cause of electric noise, and prevents a potential spark by absorbing a high voltage generated due to the influence of coil when the contact of the electrical contact portion is broken. If a spark is generated during switching of contacts, the coating layer 11c becomes degraded by the heat of the spark. In addition, when the rotor 3 (motor 1) is used in a silicone atmosphere, silicone (Si) and oxygen (O₂) in the air bind together due to the energy of a spark, generating silicon dioxide (SiO₂). Since silicon dioxide is an insulator, if the silicon dioxide becomes attached to the electrical contact portion, an electrical conduction fault is caused.

As noted above, the varistor 13 has the spark preventing function. However, when the power supply voltage inputted to the rotor 3 (motor 1) is relatively high, such as when the power supply voltage connected to the brushes 14 is 12V or higher, it may not be possible to prevent a spark sufficiently. Thus, in the present embodiment, in addition to the varistor 13, the rotor 3 is provided with elements 40 for sufficiently preventing a spark even when the power supply voltage is high (in the case of a high input operation region). That is, the varistor 13 and the elements 40 are both components for extending the lifetime of the rotor 3 (motor 1) by preventing a spark.

As illustrated in FIG. 3, the elements 40, similarly to the varistor 13, have electrodes (at a total of six locations) thermally bonded to the respective terminals 11b by soldering or welding so as to respectively electrically connect the terminals 11b to which both ends of the same-phase coil portions 31 (the series-connected two coil portions 31 in the present embodiment) are connected. As shown enlarged in FIG. 3, each of the three elements 40 may be configured of a capacitor alone (hereafter referred to as a “first element 40a”), or may be configured of a capacitor and a resistor connected in series (hereafter referred to as a “second element 40b”). That is, each of the elements 40 may include at least a capacitor and have the same configuration. The capacitance of the capacitor is set to 10 μF or above, for example. While the varistor 13 also includes a capacitor, its capacitance is on the order of several nF to tens of nF, i.e., on orders different from those of the capacitor included in the elements 40. The value of the resistor included in the second element 40b is set to 3.9Ω, for example.

[2. Test Results]

As described above, in the present embodiment, the rotor 3 prevents a spark that could be generated during switching of contacts, and protects the contact portions 11a from silicone gas when used in a silicone atmosphere, thereby achieving an increase in life. In the following, with reference to FIG. 5, the test results obtained when the motor 1 equipped with the rotor 3 of the present embodiment was operated in a silicone atmosphere will be described in comparison to a typical configuration.

First, test conditions will be described. As illustrated in FIG. 5, in the test, in a state in which the motor 1 was subjected to a load of 50 g·cm at normal temperature in a silicone atmosphere with a concentration of 700 ppm, the number of cycles of continuous operation was counted when an input of rectangular waves of 12V, 0V, and −12V was given as one cycle. FIG. 5 illustrates the test results of the rotor 3 equipped with the first element 40a (varistor 13+coating layer 11c+capacitor) and the rotor 3 equipped with the second element 40b (varistor 13+coating layer 11c+capacitor+resistance), together with the test results of a rotor with only the varistor 13 and a rotor with the varistor 13 and the coating layer 11c (and without the elements 40). In the illustrated example, the coating layer 11c was formed by applying 2 μL of oil. The test was conducted by preparing three rotors for each condition, and, in FIG. 5, the number of cycles of the rotor with the shortest lifetime among the three rotors of the same condition is indicated as a stop number of cycles (for example, “0.04×10,000”).

As will be seen from the graph of FIG. 5, the rotor 3 with the first element 40a or the second element 40b had a greatly extended lifetime, compared to the rotor without the elements 40. Specifically, the rotor with only the varistor 13 operated only up to 0.04×10,000 cycles, and the rotor with the varistor 13 and the coating layer 11c (and without the elements 40) operated only up to 0.18×10,000 cycles. In contrast, the rotor 3 equipped with the varistor 13, the coating layer 11c, and the first element 40a (capacitor) operated up to 11.7×10,000 cycles and then stopped, and the rotor 3 equipped with the varistor 13, the coating layer 11c, and the second element 40b (capacitor and resistance) operated up to 22×10,000 cycles and did not stop.

[3. Operation and Effects]

In the rotor 3, the elements 40 are connected between the terminals 11b to make a closed loop of “terminal 11b of one pole, coil portions 31, terminal 11b of another pole, element 40, and terminal 11b of one pole”. Thus, when the contact between the brushes 14 and the contact portion 11a is broken at their electrical contact portion, it is possible to allow the energy stored in the coil portions 31 to flow through the closed loop and be consumed. In this way, it is possible to prevent sparking at the electrical contact portion.

Accordingly, it is possible to prevent degradation of the coating layer 11c due to the heat of a spark. It is also possible to prevent the generation of silicon dioxide (i.e., an insulator) by the binding of silicone and oxygen in the air due to the heat of a spark. Accordingly, even when the rotor 3 is used in a silicone atmosphere, the electrical contact portion can be protected from a silicone gas and an insulator, making it possible to greatly extend the lifetime of the rotor 3 in a silicone atmosphere.

Particularly, in the case of the motor 1 in which precious metal brushes are adopted for the brushes 14, because a precious metal is subject to the influence of silicone gas, it is highly desirable to prevent the generation of a spark at the electrical contact portion, compared to the case of carbon brushes. For this purpose, the rotor 3 (motor 1) may be suitably used. Similarly, the motor 1 equipped with the rotor 3 makes it possible to greatly extend the lifetime of the motor 1 in a silicone atmosphere.

In the case in which the elements 40 with which the rotor 3 is provided include a resistor connected in series with a capacitor (i.e., in the case of second element 40b), compared to the first element 40a consisting of a capacitor alone, it is possible to better prevent sparking at the electrical contact portion. Accordingly, as illustrated in FIG. 5, with the rotor 3 equipped with the second element 40b, it is possible to extend the lifetime of the rotor 3 even more.

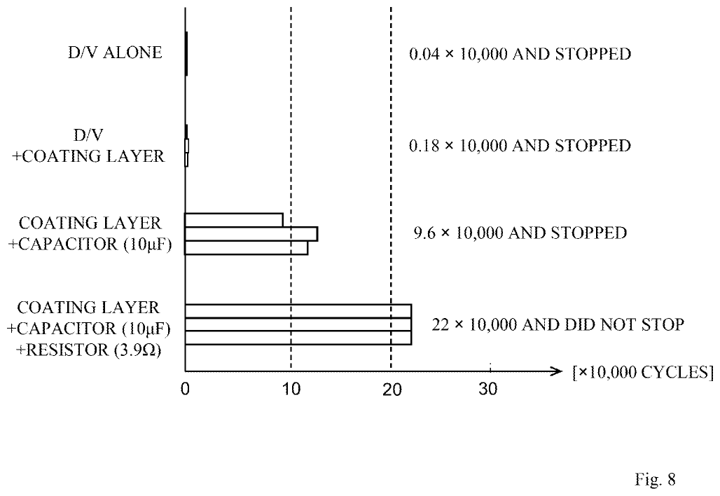

Further, the rotor 3 is provided with the varistor 13, and the varistor 13 makes it possible to enhance the spark prevention effect. Thus, the lifetime of the rotor 3 in a silicone atmosphere can be further extended. This effect is obvious from the graphs of FIG. 5 and FIG. 8. FIG. 8 is a graph illustrating the results obtained when a test was conducted under the same test conditions as in FIG. 5 while omitting the varistor 13. The details of the configuration and FIG. 8 in the case in which the varistor 13 was omitted will be described later. Comparing the graphs of FIG. 5 and FIG. 8 with respect to the third from the top of each, it is seen that the rotor 3 with the varistor 13 had a greater number of cycles of continuous operation than a rotor 3′ without the varistor 13, indicating that the lifetime of the rotor 3 was further extended by providing the varistor 13.

When the capacitance of the capacitor included in the elements 40 is 10 μF or more, it is possible to allow the energy stored in the coil portions 31 to be sufficiently consumed in the closed loop formed by the terminals 11b, the elements 40, and the coil portions 31. Accordingly, sparking can be prevented even more, and an increase in lifetime can be achieved.

With the rotor 3 (motor 1), it is possible to prevent sparking at the electrical contact portion. Accordingly, a high input (power supply voltage) of 12V or higher can be handled, so that, for example, vehicle-mounted accessories and batteries can be handled.

[4. Modification]

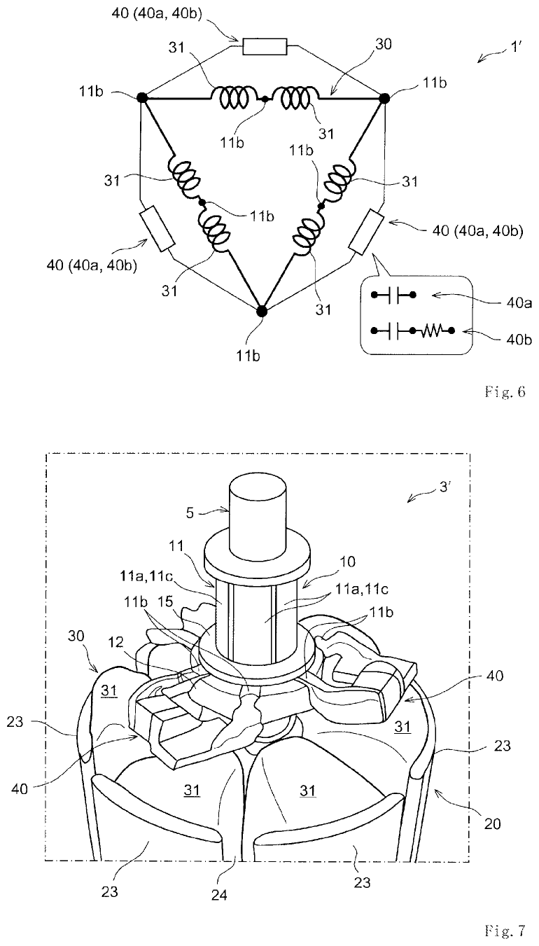

The configuration of the motor 1 and the rotor 3 is merely an example and is not limiting. For example, the varistor 13 provided in the embodiment may be omitted. FIG. 6 and FIG. 7 illustrate a circuit diagram and a schematic diagram of a motor 1′ without the varistor 13. FIG. 8 illustrates the results of a test conducted with respect to the motor 1′ without the varistor 13 under the same conditions as the test conditions of FIG. 5. The graph of FIG. 8 is identical to the graph of FIG. 5 with respect to the top and second from top.

The circuit diagram of FIG. 6 is identical to the circuit diagram of FIG. 3 with the exception of the varistor 13 being omitted. That is, similarly to the foregoing embodiment, a rotor 3′ (see FIG. 7) with which the motor 1′ of the modification is provided includes the elements 40 (first element 40a or second element 40b) connecting the terminals 11b to which both ends of the same-phase coil portions 31 are connected, and the coating layer 11c (see FIG. 7).

When the motor 1′ (rotor 3′) was tested under the same test conditions as in the foregoing embodiment, as illustrated in FIG. 8, even without the varistor 13, the lifetime of the rotor 3′ with the first element 40a or the second element 40b was greatly extended compared to the rotor without the elements 40. Specifically, the rotor 3′ equipped with the coating layer 11c and the first element 40a (capacitor) operated up to 9.6×10,000 cycles and then stopped, and the rotor 3′ equipped with the coating layer 11c and the second element 40b (capacitor and resistance) operated up to 22×10,000 cycles and did not stop. As will be seen from the test results, with the rotor 3′ without the varistor 13 and the motor 1′ equipped with the rotor 3′, it is possible, as in the foregoing embodiment, to greatly extend the lifetime of the rotor 3′ and the motor 1′ in a silicone atmosphere.

The values of the capacitance of the capacitor and resistor included in the elements 40 (40a, 40b) are exemplary and not limiting. For example, the capacitance of the capacitor may be less than 10ρF, and the resistance value may not be 3.9Ω. The elements 40 may each include a plurality of capacitors or resistors. The number and values of the capacitors and resistors may be set, as appropriate.

In the foregoing embodiment, two coil portions 31 are connected in series in the rotor 3 by way of example. However, three or more coil portions may be connected in series. In this case, as in the foregoing embodiment, elements respectively electrically connecting the terminals to which both ends of the same-phase coil portions (both ends of a plurality of coil portions 31 connected in series) are connected may be provided. When the coil portions wound around a plurality of teeth are connected in parallel, elements respectively electrically connecting terminals to which both ends of the same-phase coil portions (both ends of coil portions connected in parallel) are connected may be provided.

While in the foregoing embodiment the 4 pole/6 slot motor 1 is described by way of example, the number of poles of magnets or the number of slots of the rotor (slot number) is not particularly limited. For example, in the case of a 2 pole/3 slot motor, a coil portion wound around one tooth is provided. Accordingly, elements respectively electrically connecting terminals to which both ends of the one coil portion (i.e., both ends of the same-phase coil portion) are connected may be provided. Thus, at least, each element may be connected so as to form a closed loop that consumes the energy stored in the coil portion when the contact between the brushes 14 and the contact portion 11a is broken at their electrical contact portion.

The shapes of the stator 2 and the end bell 4 and the shape of the precious metal brushes described above are exemplary and not limiting.

As one aspect, according to the rotor of the disclosure, a closed loop is made by connecting an element between terminals, making it possible to allow an energy stored in a winding to flow through the closed loop and be consumed when the contact between a precious metal brush and a contact portion is broken at an electrical contact portion configured of the precious metal brush and the contact portion. Thus, it is possible to prevent sparking at the electrical contact portion. In this way, it is possible to prevent degradation of a coating layer due to the heat of a spark. It is also possible to prevent generation of silicon dioxide (i.e., an insulator) by the binding of silicone and oxygen in the air due to the heat of a spark. Accordingly, even when the rotor is used in a silicone atmosphere, the electrical contact portion can be protected from silicone gas and an insulator, making it possible to greatly extend the lifetime of the rotor in a silicone atmosphere.

Particularly, in the case of a motor in which precious metal brushes are adopted, it is highly desirable to prevent generation of a spark at the electrical contact portion of the rotor. The rotor and motor of the disclosure may be suitably used for such purpose. In addition, with a motor equipped with the rotor of the disclosure, it is also possible to greatly extend the lifetime of the motor in a silicone atmosphere.

What is claimed is:

1. A rotor comprising:
a rotor core that rotates integrally with a shaft and includes a plurality of radially extending teeth;
a winding including a coil portion wound around the teeth;
a commutator that is attached to the rotor core and rotates integrally with the shaft, the commutator including a contact portion with which precious metal brushes make sliding contact, and a metal commutator segment having a plurality of terminals to which the winding is bonded;
an element including a capacitor and respectively electrically connecting the terminals to which both ends of the coil portion of the same phase are connected; and
a coating layer formed of an oil applied to the contact portion.

2. The rotor according to claim 1, wherein the element includes a resistor connected in series with the capacitor.

3. The rotor according to claim 1, further comprising a varistor disposed coaxially with the shaft and having, around the commutator, electrodes respectively electrically connected to the terminals to which both ends of the coil portion of the same phase are connected.

4. The rotor according to claim 1, wherein the capacitor included in the element has a capacitance of more than or equal to 10 μF.

5. The rotor according to claim 1, wherein the precious metal brushes are connected to a power supply voltage of more than or equal to 12V.

6. A motor comprising:
a rotor core that rotates integrally with a shaft and includes a plurality of radially extending teeth;
a winding including a coil portion wound around the teeth;
a commutator that is attached to the rotor core and rotates integrally with the shaft, the commutator including a contact portion with which precious metal brushes make sliding contact, and a metal commutator segment having a plurality of terminals to which the winding is bonded;
an element including a capacitor and respectively electrically connecting the terminals to which both ends of the coil portion of the same phase are connected;
a coating layer formed of an oil applied to the contact portion;
a stator which includes a permanent magnet fixed to an inner peripheral surface of a bottomed and tubular housing, and rotatably supports one end of the shaft; and
an end bell having the precious metal brushes and fixed to an opening portion of the housing.
